(19) United States
(12) Patent Application Publication
(10) Pub. No.: US 2014/0018956 A1
(43) Pub. Date: Jan. 16, 2014

(54) ARTICLE VENDING MACHINE AND METHOD FOR AUTHENTICATING RECEIVED ARTICLES

(71) Applicant: Redbox Automated Retail, LLC, Oakbrook Terrace, IL (US)

(72) Inventors: Franz Kuehnrich, Bartlett, IL (US); Jonathan Palmer, Chicago, IL (US)

(73) Assignee: Redbox Automated Retail, LLC, Oakbrook Terrace, IL (US)

(21) Appl. No.: 14/028,154

(22) Filed: Sep. 16, 2013

Related U.S. Application Data
(63) Continuation of application No. 12/876,046, filed on Sep. 3, 2010, now Pat. No. 8,538,581.

(51) Int. Cl. G07F 7/06; G07F 17/00

(52) U.S. Cl. CPC G07F 7/069; G07F 17/005
USPC 700/237

(57) ABSTRACT

An article dispensing machine, system and method for authenticating an article returned to the article dispensing machine and an article for use in such a machine and system are disclosed herein. The returned article comprises an authentication code disposed on the surface of the returned article and a layer that is substantially opaque in visible light and at least partially overlays the authentication code. The article dispensing machine comprises a light source for illuminating the surface of the returned article so that the authentication code is visible through the layer, an image capture device for capturing an image of the authentication code when the surface is illuminated, and a processor for comparing the captured image to a master authentication code.

### CROSS REFERENCE TO RELATED APPLICATION

This application is a continuation of U.S. application Ser. No. 12/876,046, filed on Sep. 3, 2010, entitled “ARTICLE VENDING MACHINE AND METHOD FOR AUTHENTICATING RECEIVED ARTICLES,” which is incorporated herein by reference in its entirety. The subject matter of the present application relates to and can work in conjunction with the subject matter of U.S. patent application Ser. No. 12/861,689, filed on Aug. 23, 2010, entitled “ARTICLE RETURN SYSTEM AND METHOD OF USING SAME” which is incorporated herein by reference in its entirety.

### TECHNICAL FIELD

The present invention relates to improvements in article dispensing machines and components and methods related to the same. More particularly, the present invention relates to a digital video disc (DVD) dispensing apparatus and method for authenticating returned DVDs having a security feature.

### BACKGROUND AND SUMMARY OF THE INVENTION

While the present invention is often described herein with reference to a digital video disc distribution system, an application to which the present invention is advantageously suited, it will be readily apparent that the present invention is not limited to that application and can be employed in article dispensing systems used to distribute a wide variety of rentable articles.

An improved DVD dispensing machine is disclosed in commonly owned U.S. Pat. No. 7,234,609, which is herein incorporated by reference in its entirety. The invention of the U.S. Pat. No. 7,234,609 and the present invention can function as a DVD dispensing machine-based distribution system that will typically have multiple units of each new release per DVD dispensing machine. The dispensing machines of the U.S. Pat. No. 7,234,609 and the present invention can stock up to two thousand DVDs (movies, games or other entertainment content), making the system competitive with existing brick-and-mortar video rental superstores.

The dispensing machine and system of the U.S. Pat. No. 7,234,609 and the present invention distinguishes itself from such stores by offering major benefits not conventionally offered by such stores, including additional cross-marketing programs (e.g., promotional rentals for a certain amount of dollars spent at the hosting store) and convenience (e.g., open always).

The dispensing machine of the U.S. Pat. No. 7,234,609 and the present invention yields a competitive advantage in the DVD rental marketplace by offering consumers cross-marketing/promotional programs, convenience of selection (e.g., computer-based searches for movies and recommendations based on consumer profiles), and potentially extended hours. The present invention employs a more cost-effective, convenient platform than brick-and-mortar stores. In addition, with the present invention, DVD dispensing machines can be situated in hosting locations having high foot traffic, such as at a popular grocery store, restaurant, drug store, and/or other popular hosting locations.

The dispensing machine of the U.S. Pat. No. 7,234,609 and the present invention can be operated at a substantial savings over the costs associated with traditional brick-and-mortar video rental stores. For example, the present invention does not require hourly employees manning the dispensing machines or restocking them with inventories, due to the ability of the article transport storage units to be delivered to/picked up from host locations by third-party delivery services, such as traditional or contracted courier services.

Unlike brick-and-mortar stores, the dispensing machine of the U.S. Pat. No. 7,234,609 and the present invention does not require an on-site store manager because all operational decisions can be made at a centralized location by a management team located remote from the hosting locations. Unlike brick-and-mortar stores, the dispensing machine of the U.S. Pat. No. 7,234,609 and the present invention does not require significant physical space. Unlike brick-and-mortar stores, the dispensing machine of the U.S. Pat. No. 7,234,609 and the present invention has low operating costs because no heating or air conditioning is required for the dispensing machines and they consume a relatively low level of electrical energy. In addition, the dispensing machine of the U.S. Pat. No. 7,234,609 has low maintenance costs and downtime. Furthermore, the dispensing machines disclosed herein may also be situated outdoors and, where necessary, may include heating and/or air conditioning units to accommodate less temperate climates.

The dispensing machine of the U.S. Pat. No. 7,234,609 and the present invention addresses the shortcomings of traditional brick-and-mortar stores in a convenient and cost-effective delivery vehicle having the added bonus of serving as an effective promotional platform that drives incremental sales to hosting locations. In addition, the dispensing machine of the U.S. Pat. No. 7,234,609 and the present invention overcomes these disadvantages by at least offering more new releases and older selections for any given time period, and lower cost per viewing with significantly more convenience than Internet-based and pay-per-view services.

The dispensing machine of the U.S. Pat. No. 7,234,609 and the present invention is a fully automated, integrated DVD movie video and video game rental and/or purchase systems. It preferably incorporates robust, secure, scalable software that provides a fully personalized user experience and real-time feedback to hosting locations and advertisers, scalable hardware that leverages existing technologies such as touch screen, focused audio speakers and plasma video monitors, technology utilizing the Internet through a system website, and an article transport storage unit that facilitates the exchange of new DVDs for old DVDs in each machine with virtually no need for human intervention. These technologies and others fill long-felt needs in the art and give advantages over conventional video distribution options. The dispensing machine of the U.S. Pat. No. 7,234,609 and the present invention functions as much as a promotional platform as it does a rental kiosk.

By utilizing the dispensing machines and the fully-interactive, real-time, linked Internet website, consumers can rent one or more DVD movie videos, video games, or other entertainment content directly from dispensing machines as well as indirectly by making a rental reservation through the website for later pickup at a conveniently located machine. These dispensing machines are preferably networked with each other, with the inventory control and/or supply office and with the system website by phone-line, DSL, or other Internet connection at each hosting location. Through this linked network, the rental experience for each consumer can be customized based on a profile for each consumer, such as via personalized home pages and rental screens.

With such DVD dispensing machines, there exists the potential for a customer to attempt to return a DVD other than the DVD that the customer rented and retain the rented DVD for his or her own use. Conventional DVD dispensing machines have used a device such as a code printed on the DVD or the DVD case, which was validated by the dispensing machine, to defeat such attempted fraud. Nevertheless, such conventional validation efforts may be defeated by users who create a photocopy of the authentic label and apply it to the non-authentic DVD or DVD case. Furthermore, such conventional validation systems typically suffered from one of the following drawbacks: they were expensive to implement, they could be readily defeated through duplication, or the device was susceptible to being damaged, thereby resulting in a false rejection of an authentic DVD.

The present invention is directed to DVD dispensing machines, a system and method for authenticating returned DVDs and DVDs or other media storage devices for use in such machines and systems. In one embodiment, the system employs a DVD having a security feature such as a code that cannot be copied by a standard photocopier. The DVD has an encrypted authentication code, such as a data matrix code applied as a first layer in a carbon-containing ink. A second layer overtop of and concealing the authentication code may be a black square applied in substantially carbon free ink, such that the naked eye sees only the black square, not the underlying authentication code. When the customer returns the DVD, the article dispensing machine exposes the DVD surface to infrared light, thereby enabling the dispensing machine to read the underlying authentication code. The system overcomes many of the drawbacks of conventional authentication systems in that it is inexpensive to implement, it cannot be defeated through simple means for duplication of a label and it is robust, at least because the system is not prone to false rejections of authentic DVDs. Other features and advantages are provided by the following description and drawings.

### BRIEF DESCRIPTION OF THE DRAWINGS

FIG. 1 is an illustration of a system for communicating and processing information in a network of article dispending machines and dispensing apparatus;

FIG. 2 is a perspective view of an article dispensing machine constructed in accordance with the principles of the present invention;

FIG. 3 is a partially open perspective view of a portion of the article dispensing machine of FIG. 2 with certain elements removed for clarity;

FIG. 4 is a plan view of the portion of the article dispensing machine of FIG. 3;

FIG. 5 is a flowchart illustrating an order of operations performed by an article dispensing machine for authenticating a returned article;

FIG. 6 is a schematic drawing of a first embodiment of portions of an article dispensing machine constructed in accordance with the principles of the present invention;

FIG. 7 is a schematic drawing of a second embodiment of portions of an article dispensing machine constructed in accordance with the principles of the present invention;

FIG. 8 is a plan view of a DVD in accordance with the principles of the present invention;

FIG. 9 is a plan view of the DVD in FIG. 8 when exposed to a first predetermined wavelength of electromagnetic radiation; and

FIG. 10 is a plan view of the DVD of FIG. 8 housed in a case.

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

FIGS. 1-3 illustrate an article dispensing machine designated 230. Article dispensing machine 230 may be one of a plurality of article dispensing machines included within an article distribution system having a plurality of such machines situated at a plurality of hosting locations. The article dispensing machines of a particular article distribution system preferably form a network. As such, those machines are preferably in communication with each other and/or with a central server or central controller.

As shown in FIG. 1, each article dispensing machine 230 includes a dispensing machine processor 300, also referred to herein as a vending controller, which is connected to a user interface control system 234, an image capture device 235, an infrared light source 236 and, preferably, an article sensor 237, collectively referred to as “the peripheral devices.” The processor 300 is capable of executing various programs to provide input to and/or receive outputs from the peripheral devices. Suitable processors for such use are known to those of skill in the art. In addition, the processor is operably connected to at least one memory storage device 281, such as a hard-drive or flash-drive or other suitable memory storage device.

Article dispensing machine memory storage device 281 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, article dispensing machine memory storage device 281 may incorporate electronic, magnetic, optical, and/or other types of storage media. Article dispensing machine memory storage device 281 can have a distributed architecture where various components are situated remote from one another, but are still accessed by processor. Article dispensing machine memory storage device includes an article dispensing machine database 282.

The article dispensing machines 230 preferably comprise a network of machines in communication with one another. As shown in FIG. 1, in the preferred configuration, the article dispensing machines 230 are networked with one another via a central server or central controller 302 in a hub-and-spoke system. However, optionally, the article dispensing machines may be connected and communicate directly with one another, and/or subsets of article dispensing machines may communicate with one another directly as well as with the central server 302.

Generally, in terms of hardware architecture, the central server 302 includes a central processor and/or controller, central memory, and one or more input and/or output (I/O) devices (or peripherals) that are communicatively coupled via a local interface. The architecture of the central server is set forth in greater detail in U.S. Pat. No. 7,234,609, the contents of which are incorporated herein by reference. Numerous variations of the architecture of the central server can be understood by one of skill in the art and are encompassed within the scope of the present invention.

Steps and/or elements, and/or portions thereof of the system and method may be implemented using a source program, executable program (object code), script, or any other entity comprising a set of instructions to be performed. When a source program, the program needs to be translated via a compiler, assembler, interpreter, or the like, which may or may not be included within the memory, so as to operate properly in connection with the operating system (O/S). Furthermore, the software embodying the present system and method can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada. frequency (RF) or other transceiver, a telephonic interface, a bridge, and a router.

When article dispensing machine 230 is in operation, the article dispensing machine processor is configured to execute software stored within article dispensing machine memory, to communicate data to and from the dispensing machine memory, and to generally control operations of article dispensing machine pursuant to the software. The software aspects of the present invention and the O/S, in whole or in part, but typically the latter, are read by processor, perhaps buffered within the processor, and then executed.

When the present system and method, or aspects thereof, are implemented in software, it should be noted that the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The present invention can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

For communication with the central server 302, article dispensing machine 230 is equipped with network communication equipment and circuitry. In a preferred embodiment, the network communication equipment includes a network card such as an Ethernet card. In a preferred network environment, each of the plurality of article dispensing machines 230 on the network is configured to use the TCP/IP protocol to communicate via the network 301. It will be understood, however, that a variety of network protocols can also be employed, such as IPX/SPX, Netware, PPP and others. It will also be understood that while a preferred embodiment of the present invention is for article dispensing machine 230 to have a “broadband” connection to the network 301, the principles of the present invention are also practicable with a dialup connection using a standard modem. Wireless network connections are also contemplated, such as wireless Ethernet, satellite, infrared and radio frequency networks.

The central controller 302 communicates with the article dispensing machine controllers 300 via the network 301. The central controller 302 is preferably located at a central station or office that is remote from the plurality of article dispensing machines 230. The central controller 302 can operate as the server for communicating over the network 301 between the plurality of article dispensing machines 230. The central controller 302 receives communications and information from the article dispensing machines 230, and also transmits communications and information to the machines 230. For example, when a DVD rental transaction is performed at the article dispensing machine 230, transaction data such as the rented DVD title is then transmitted from the machine 230 to the central controller 302 via the network 301. It will be understood that central servers in general, such as the central controller 302, are often distributed. A plurality of central servers/controllers 302 may optionally be arranged in “load balanced” architecture to improve the speed and efficiency of the network. To accomplish the implementation of multiple controllers 302, the controllers 302 may be in communication with a router/distributor 303.

The central controller 302 is also in communication with a central database 304. The central database 304 stores information regarding the transaction network. For example, the central database 304 stores data regarding the vending inventory at each of the plurality of article dispensing machines 230. The central database 304 also stores sales information regarding the sales quantities of the vending merchandise stored in the machines 230. For example, the central database 304 stores information regarding the sales totals for each DVD title and for each machine 230 vending location. Central database 304 also stores user information and rental transaction information, such as user IDs, PINs, the date on which DVDs are due to be returned, and the date on which DVDs were rented from the machines 230. Some of this information is also preferably stored in article dispensing machine database 282. The central database 304 may also store a master inventory list of the DVDs housed in each of the dispensing machines.

Central database 304 is preferably a relational database, although other types of database architectures may be used without departing from the principles of the present invention. For example, database 304 may be a SQL database, an Access database or an Oracle database, and in any such embodiment have the functionality stored herein. Central database 304 is also preferably capable of being shared, as illustrated, between a plurality of central controllers 302 and its information is also preferably capable of being transmitted via network 301. It will be understood that a variety of methods exist for serving the information stored in central database 304. In a preferred embodiment, .net and Microsoft Reporting Services are employed, however, other technologies such as ODBC, MySQL, CFML and the like may be used.

The central controller 302 and central database 304 are also preferably accessible by a personal computer 306. The personal computer 306 will be understood as comprising hardware and software consistent with marketable personal computers, such as a display monitor, a keyboard, a pointing device, and a microprocessor with memory. The personal computer also comprises Internet browser software such as Firefox or Internet Explorer. Using the browser software, a user at the personal computer 306 can access a web interface through the central controller 302. To that end, central controller 302 preferably comprises web server software such as IIS or Apache. It will be understood that a variety of web server software and web browser software exists to implement the principles of the present invention without departing therefrom. Through the web browser software, the personal computer 306 communicates with the central controller 302 and allows the user to login to a central command functionality of the central controller 302 and to view and modify data stored in the central database 304. The browser interface also allows the user to perform certain system functions, which will affect the inventory and behavior of the article dispensing machines 230.

In a preferred embodiment, a financial server 305 is also in communication with the network 301. It will be understood that a variety of financial services exist for processing financial information via the Internet and other networks 301. Those services allow for the processing of credit card and debit card information, so that users of the services do not have to interface directly with credit and debit card companies. In FIG. 1, the financial server 305 is illustrated as a single server, although the financial server 305 may comprise an entire sub-network of financial servers 305 responsible for processing financial information.

As shown in FIG. 2, article dispensing machine 230 includes a machine housing 232 with front, rear, top, bottom and side panels. The machine housing 232 is preferably a combination molded fiberglass and sheet metal cabinet. However, those skilled in the art will appreciate that the housing can be constructed from a variety of other suitable materials and with a variety of other suitable manufacturing techniques.

As shown most clearly in FIG. 2, a user interface portion 234 of housing 232 includes a card reader 240, a keypad and/or touch screen 242 and an article transfer opening 244. The card reader 240 is preferably designed in known fashion to read magnetically encoded membership and/or credit cards for authorizing the distribution of articles of inventory through the article transfer opening 244. Keypad and/or touch screen 242 permits consumers and/or inventory stocking personnel to communicate with the dispensing machine 230 and/or a central office linked in electrical communication with the dispensing machine. Keypad and/or touch screen 242 also permits consumers and/or inventory stocking personnel to enter appropriate commands directed to carrying out specific machine tasks. It will be appreciated that the optional touch screen includes a monitor made with known technologies making it capable of being utilized as a user interface for entry of commands designed to carry out machine tasks.

Furthermore, it will be appreciated that additional user interface portions having additional or even identical user interface components could be incorporated within article dispensing machine 230. For example, these components could be incorporated on other panels of the housing 232 of machine 230 so that the machine can be used simultaneously by multiple consumers, translating into more efficient distribution of articles in high traffic areas.

As shown in FIG. 3, the dispensing machine contains a light source 236, positioned to illuminate a DVD received by the receptacle 244 with electromagnetic radiation of a predetermined wavelength range outside of the visible light spectrum (300 nm to 760 nm). In a preferred embodiment, the light source 236 illuminates the DVD with electromagnetic radiation within the infrared light range (1 mm to 750 nm). The dispensing machine also contains an image capture device 235 positioned to photograph or otherwise capture the image of at least a portion of the surface of the returned DVD. The image capture device is preferably a digital camera, such as a charge coupled device (CCD) camera or a complementary metal oxide semiconductor (CMOS) camera, or a personal computer camera that are configured to capture images in the first predetermined wavelength range as known in the art, such as e.g. an infrared camera. Alternatively, the image capture device could be a constant recording device such as a digital video camera configured to capture images in the first predetermined wavelength range. The image capture device preferably has an automatic focusing feature as is known in the art.

The dispensing machine may further include an article sensor 237 for detecting the presence of an article inserted into the receptacle. The article sensor 237 may be simple mechanical switch, a proximity sensor, a light bar, or any other suitable sensor known in the art for detecting presence. In the preferred embodiment, the article sensor 237 detects the presence of the returned DVD and activates the infrared light source 236. The infrared light source 236 is preferably turned on after the returned DVD has been inserted into the receptacle 244.

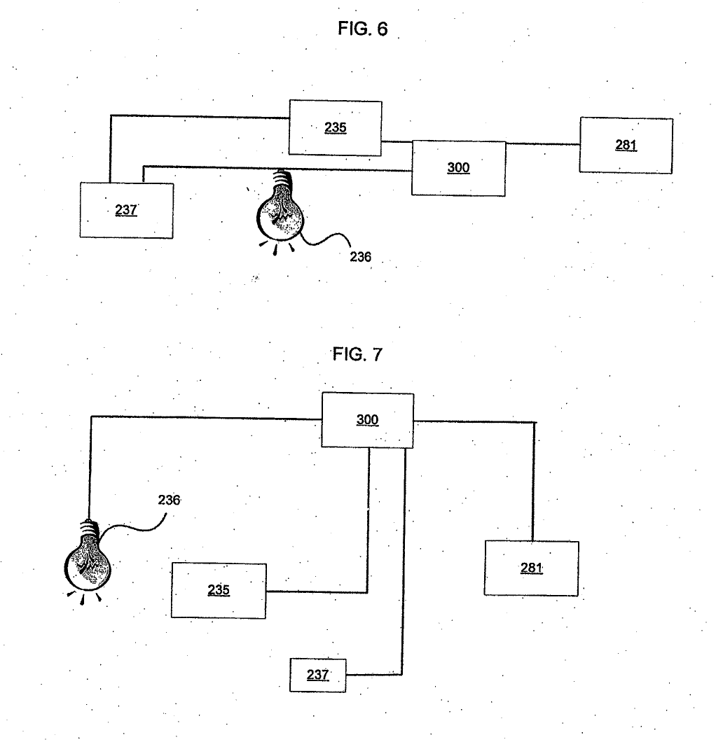

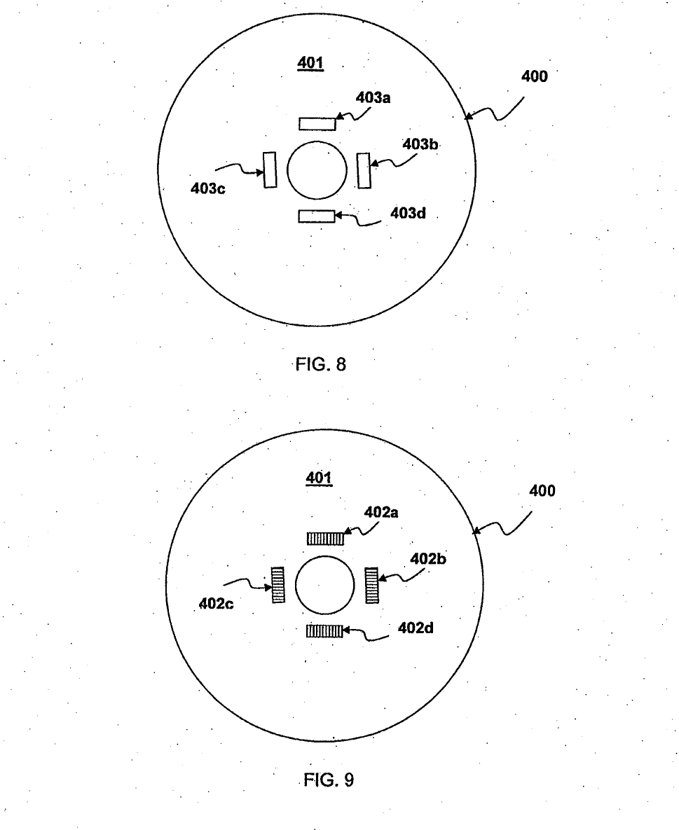

FIG. 6 shows a schematic of a portion of the system for authenticating an article, in which the detection of the presence of an article by article sensor 237 directly activates the light source 236. The triggering of the sensor may directly activate the light source 236 or, as shown in schematic FIG. 7, the signal may be sent to the processor 300, which activates the light source 236.

Alternatively, the light source 236 could be activated by the initiation of the return process by the consumer. For example, the user-selection of a “Return” option via the user interface may cause the processor to activate the infrared light source 236. Yet, alternatively, the light source could constantly be on whenever the machine has power.

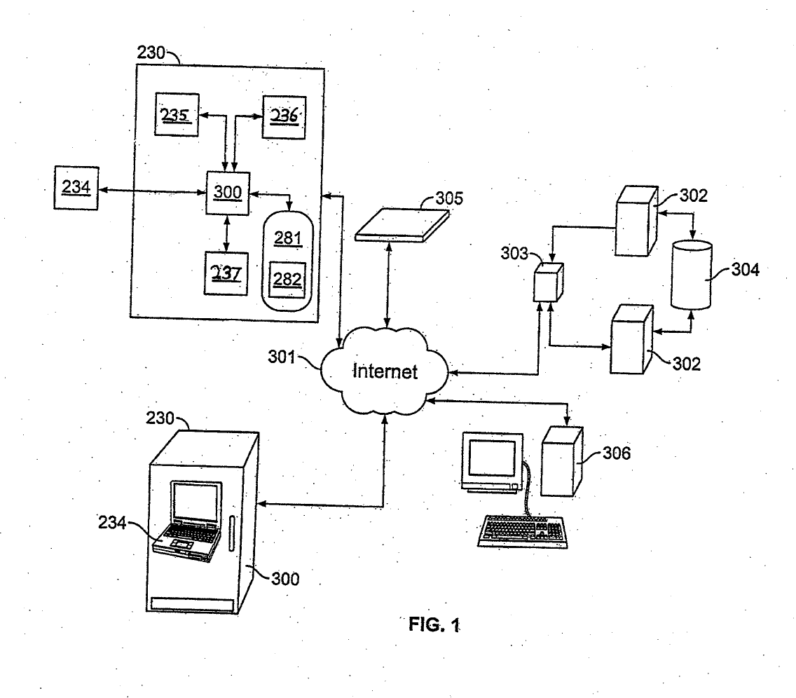

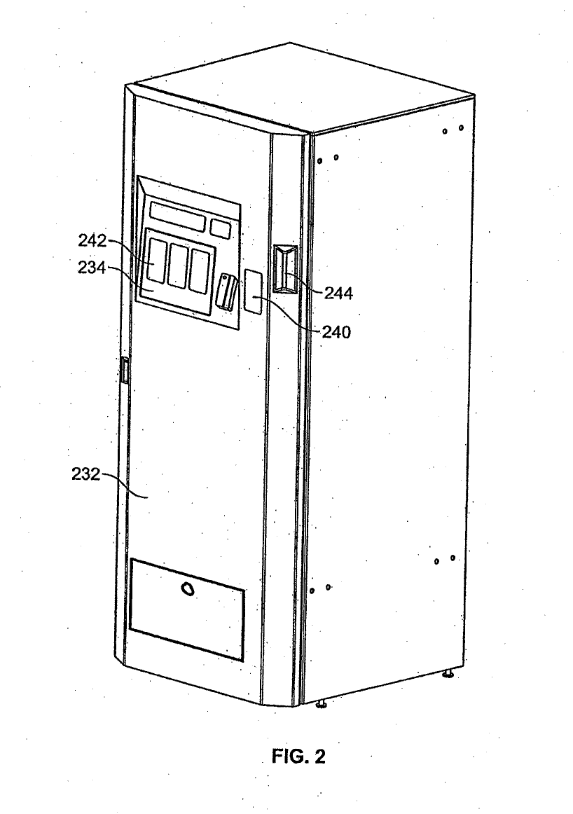

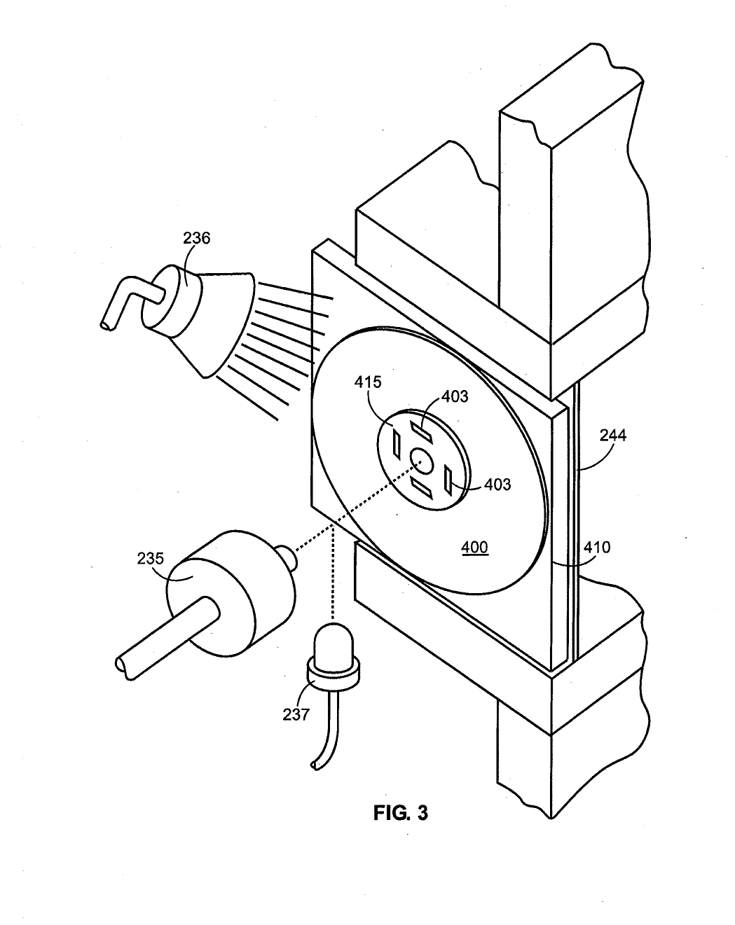

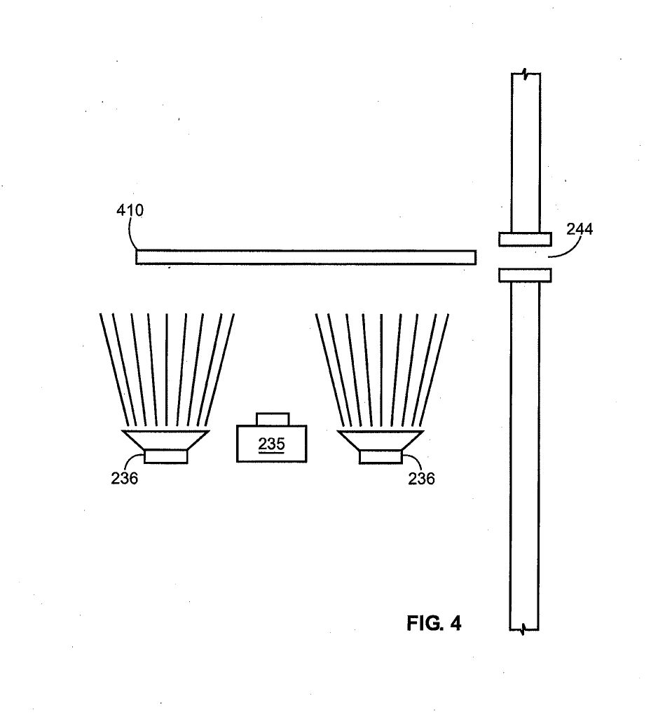

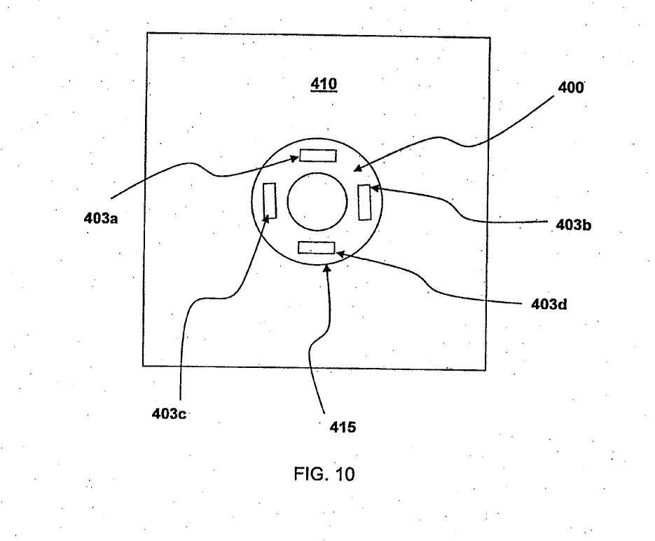

As shown in FIGS. 3 and 4, the light source 236 is positioned to illuminate a first surface 401 of the returned DVD with infrared light. FIG. 9 shows a first surface 401 of the DVD 400. The first surface has a machine-readable authentication code 402, which is substantially visible when exposed to the first predetermined wavelength and forming a first layer. In a preferred embodiment, in which the light source 236 provides infra red light, the machine-readable authentication code 402 may be a carbon containing ink, which, when exposed to infrared light, is visible. As shown in FIG. 9, the authentication code 402 is preferably a data matrix that represents an alpha-numeric sequence. However, the authentication code could be a bar code, numerical or binary sequence or any other symbol. The authentication code is preferably printed on the first surface of the DVD in a plurality of locations 402 a, b, c, d to increase the ease of reading the authentication code and to allow the authentication code to be read even if one of the authentication codes is damaged. The authentication code may also be printed to a label affixed to the first surface of the DVD. The authentication code may comprise toner imaged onto the DVD via electron beam or ion deposition techniques, electrophotographic or electrographic methods or via ink jet. As shown in FIG. 10, in a preferred embodiment, the DVD is contained within a case 410 having an opening 415 aligned with the location of the authentication code or codes 402, so that the authentication codes are not concealed by the DVD case. Alternatively, the DVD case could include a transparent section aligned with the authentication code thereby allowing the authentication code to be viewed through the DVD case.

FIG. 9 shows the first surface of DVD 400 as it appears in visible light. A second layer 403 is applied in a medium that is substantially opaque in visible light, but substantially transparent when exposed to the first predetermined wave-length of electromagnetic radiation. For example, in the preferred embodiment, the second layer is preferably a substantially carbon free ink, which is applied overtop of and at least partially concealing the authentication codes. Preferably, the second layers 403 a, b, c, and d are solid geometric shapes that entirely cover and conceal the authentication codes that form the first layers. The second layers are preferably printed in black ink or another color of ink sufficiently opaque when viewed in white light. The substantially carbon free ink shapes conceal the authentication codes 402a-d and prevent them from being viewed by the naked eye in white light or from being copied by a standard photocopying machine. When the first surface 401 of DVD 400 is exposed to infrared light, the carbon-containing authentication codes are visible through the second layers, which are sufficiently transparent in infrared light. The second layers may be applied by litho or flexographic techniques, or by ink jet, electrophotographic or electrographic methods.

Turning now to the functioning of the machine during a consumer transaction, as a consumer approaches an article dispensing machine, the consumer observes the display monitor and the user interface 234. The consumer may also observe a plasma/LCD monitor displaying marketing information, or a lightbox containing marketing information for branding the vending apparatus 230. The consumer then enters the appropriate commands at the user interface control 234 associated with the dispensing machine to select a DVD to be dispensed by the machine. The user interface can employ simple menus and a fixed set of keys for consumers to make their selections, it can employ break-resistant touch screens, or it can employ a combination of both. Once a selection has been made, the consumer then merely inserts a card, such as a credit card, into the card reader 240 positioned at the front of the dispensing machine 230 and, in response, the machine will dispense the selected DVD without the need for further input by the consumer.

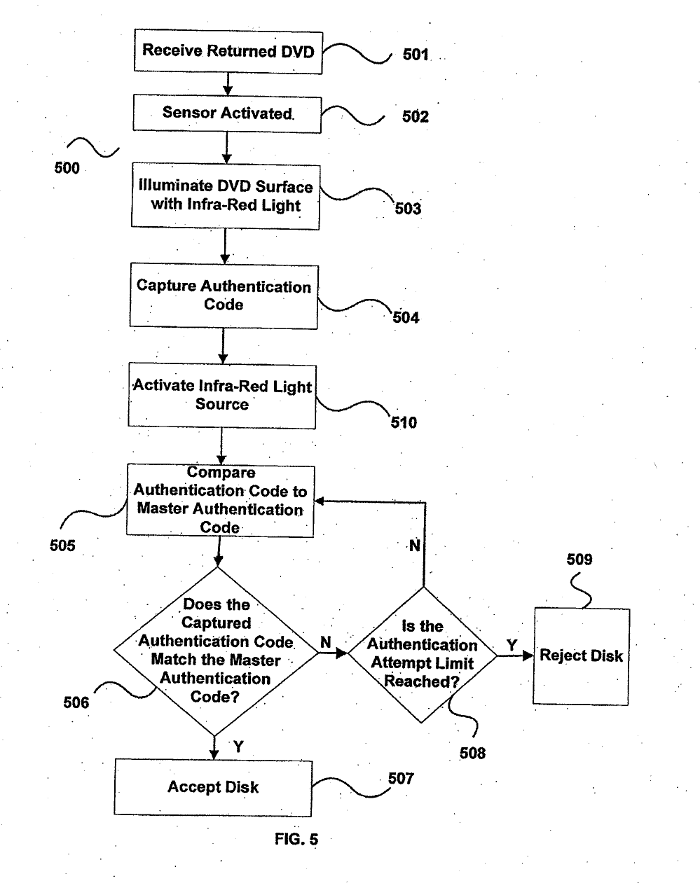

FIG. 5 shows a process 500 for authenticating a returned DVD. The consumer may initiate the return process via the user interface 234, for example by selecting the option “RETURN A DISK” on a touchscreen. The consumer then inserts the DVD into the dispensing/receiving receptacle 244, which may be an opening in the front panel of the machine, and the DVD is received by the article vending machine through the opening as illustrated by step 501.

Once the DVD is inserted in the article transfer opening 244, optionally, sensor 237 is triggered by the receipt of the DVD as shown in step 502. The surface of the DVD is illuminated by the infrared light source 236, as shown in step 503. Then, image capture device 235 is activated and captures the image of at least a portion of the first surface 401 of the DVD, including the authentication code as shown in step 504. The image capture device 235 captures the image of the authentication code and converts it to a digital file. The image capture device 235 may capture a series of images of the authentication code in rapid succession, or, in the case of a digital video camera, may take a continuous video of the authentication code. The image capture device may further capture the image of the authentication code from multiple locations on the DVD 402 a, b, c, and d. The digital file or files are then transmitted to the processor 300 where the authentication code is read from the digital file and compared to a pre-programmed or “master” authentication code as shown in steps 505-506.

If the authentication code matches the master authentication code, the disk is authenticated and the processor continues the return process as shown in step 507. If the authentication code cannot be read or does not match the master authentication code, the processor may be programmed to attempt to read the authentication code from a subsequently transmitted digital file. This process may repeat the steps of reading 505 and comparison 506 for a predetermined number of digital files or a predetermined time period, referred to herein as the authentication attempt limit as shown in step 508. If the authentication attempt limit has been reached and the authentication code has not been authenticated, the authentication process is terminated and the DVD is rejected 509. The rejected DVD may be ejected from the receptacle 244 for return to the user and the user interface may display a message to the consumer that the disk could not be authenticated.

Alternatively, the rejected DVD may be retained by the article dispensing machine and quarantined. The DVD may be quarantined by being physically transferred to a separate holding area contained within the machine. Preferably, the DVD is quarantined by designating the DVD as not to be vended or “inoperable” in the article dispensing machine database 282. DVDs marked as “inoperable” may be stored with the other inventory in an open storage slot 369 in the vending machine.

In the embodiments in which the infrared light source is activated each time a DVD is returned (instead of remaining on when the machine has power), the infrared light source 236 and the image capture device 235 may be set to be deactivated after a predetermined time period as shown in step 510. In the preferred embodiment, the infrared light source and the image capture device are activated for three to four seconds. Alternatively, the processor 300 may be configured to deactivate the image capture device and infrared light source after the authentication code encryption has successfully been authenticated or after the authentication attempt limit has been reached.

In the preferred embodiment, the first surface of the DVD 401, in addition to having an authentication code thereon, also includes an article identifier. The article identifier is preferably a bar code that encodes a serial number uniquely assigned to the DVD, but may also be a data matrix or alpha-numeric sequence or the like. The article identifier is printed on the first surface of the DVD in a carbon-containing ink, thereby enabling the article identifier to be viewed and photographed or otherwise captured in infrared light, and eliminating the need for a second light source. The image capture device may also captures the article identifier at the same time that the authentication code is captured by the image capture device. Thus, the digital images transferred to the processor contain both the authentication code and the article identifier. However, in an alternate embodiment, the article identifier and the authentication code may be captured and/or transferred separately.

After the DVD has been authenticated by the processor (or concurrently with the authentication process) the article identifier is read from the digital image. The article identifier is then used to identify the returned DVD during the return and restocking process and is used to update an article dispensing machine inventory database. The article identifier may further be used in the billing process to identify the rented article that the customer has returned and to calculate the charge for the rental, the details of which are set forth in U.S. Pat. No. 7,234,609, the contents of which are herein incorporated by reference in their entirety.

In certain embodiments, the article identifier and the authentication code may both be components of a single device, for example a data matrix in which a first section of the data matrix represents the authentication code and a second section represents the article identifier.

Any process descriptions or blocks in figures represented in the figures should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

While the specific embodiments have been illustrated and described, numerous modifications come to mind without significantly departing from the spirit of the invention, and the scope of protection is only limited by the scope of the accompanying Claims.

What is claimed is:

1. An article dispensing machine for authenticating a returned article, the article dispensing machine comprising:
a receptacle for receiving the returned article, the returned article comprising an authentication code disposed on a surface of the returned article and a layer substantially opaque in visible light and at least partially overlaying the authentication code;
an article sensor configured to detect a presence of the returned article;
a light source in communication with the article sensor and configured to illuminate the surface of the returned article with electromagnetic radiation in a predetermined range in response to the article sensor detecting the presence of the returned article, wherein when the surface is illuminated, the authentication code is visible through the layer;
an image capture device configured to capture an image of the authentication code when the surface is illuminated; and
a processor in communication with the image capture device, wherein the processor is configured to identify the authentication code from the image and compare the authentication code that was identified to a master authentication code.

2. The article dispensing machine of claim 1, wherein the authentication code is multiplicatively disposed on the surface of the returned article, and wherein the image capture device is configured to capture multiple images of one or more of the multiplicatively disposed authentication codes.

3. The article dispensing machine of claim 1, wherein if the processor cannot identify the authentication code from the image, the processor is configured to:
access an additional image of the authentication code captured by the image capture device;
identify the authentication code from the additional image; and
compare the authentication code that was identified from the additional image to the master authentication code.

4. The article dispensing machine of claim 3, wherein the processor is configured to repeat the identification and the comparison for a predetermined number of images.

5. The article dispensing machine of claim 3, wherein the processor is configured to repeat the identification and the comparison until a predetermined time period is reached.

6. The article dispensing machine of claim 1, wherein when the surface is illuminated, an article identifier disposed on the surface of the returned article is also visible through the layer.

7. The article dispensing machine of claim 6, wherein the processor is further configured to:
identify the article identifier from the image; and
update an inventory database according to the article identifier.

8. The article dispensing machine of claim 1, wherein the predetermined range is in an infrared spectrum, the authentication code is comprised of a carbon-containing ink visible in the infrared spectrum, and the layer is comprised of a substantially carbon-free ink.

9. A method of authenticating a returned article, the method comprising:
detecting, by an article sensor, a presence of the returned article via a receptacle, the returned article comprising an authentication code disposed on a surface of the returned article, and a layer substantially opaque in visible light and at least partially overlaying the authentication code;
illuminating, by a light source in response to the detecting by the article sensor, the surface of the returned article with electromagnetic radiation in a predetermined range, wherein when the surface is illuminated, the authentication code is visible through the layer;
capturing, by an image capture device, an image of the authentication code when the surface is illuminated;
identifying, by a processor, the authentication code from the image; and
comparing the authentication code that was identified to a master authentication code.

10. The method of claim 9, wherein the authentication code is multiplicatively disposed on the surface of the returned article, and wherein capturing the image comprises capturing multiple images of one or more of the multiplicatively disposed authentication codes.

11. The method of claim 9, wherein if the processor cannot identify the authentication code from the image, the method further comprises:
accessing an additional image of the authentication code captured by the image capture device;
identifying the authentication code from the additional image; and
comparing the authentication code that was identified from the additional image to the master authentication code.

12. The method of claim 11, further comprising: repeating the identifying and the comparing for a predetermined number of images.

13. The method of claim 11, further comprising: repeating the identifying and the comparing until a predetermined time period is reached.

14. The method of claim 9, wherein when the surface is illuminated, an article identifier disposed on the surface of the returned article is also visible through the layer.

15. The method of claim 9, wherein the method further comprises:
identifying, by the processor, the article identifier from the image; and
updating an inventory database according to the article identifier.

16. The method of claim 9, wherein the predetermined range is in an infrared spectrum, and wherein the authentication code is comprised of a carbon-containing ink visible in the infrared spectrum, and the layer is comprised of a substantially carbon-free ink.

17. A non-transitory computer readable medium comprising instructions, for execution on a computer processor and for performing steps for authenticating a returned article, the steps comprising:
detecting, by an article sensor, a receipt of the returned article via a receptacle, the returned article comprising an authentication code disposed on a surface of the returned article, and a layer substantially opaque in visible light and at least partially overlaying the authentication code;
configuring a light source to illuminate, in response to the article sensor detecting the receipt of the returned article, the surface of the returned article with electromagnetic radiation in a predetermined range, wherein when the surface is illuminated, the authentication code is visible through the layer;
configuring an image capture device to capture an image of the authentication code when the surface is illuminated;
identifying the authentication code from the image; and
comparing the authentication code that was identified to a master authentication code.

18. The non-transitory computer readable medium of claim 13, wherein the authentication code is multiplicatively disposed on the surface of the returned article, and wherein the image capture device captures multiple images of one or more of the multiplicatively disposed authentication codes.

19. The non-transitory computer readable medium of claim 17, wherein if the authentication code cannot be identified from the image, the steps further comprise:
accessing an additional image of the authentication code captured by the image capture device;
identifying the authentication code from the additional image; and
comparing the authentication code that was identified from the additional image to the master authentication code.

20. The non-transitory computer readable medium of claim 19, wherein the steps further comprise: repeating the identifying and the comparing for a predetermined number of images

21. The non-transitory computer readable medium of claim 19, wherein the steps further comprise: repeating the identifying and the comparing until a predetermined time period is reached.

22. The non-transitory computer readable medium of claim 17, wherein the predetermined range is in an infrared spectrum, and wherein the authentication code is comprised of a carbon-containing ink visible in the infrared spectrum and the layer is comprised of a substantially carbon-free ink.

23. The non-transitory computer readable medium of claim 17, wherein the captured image is at least one of digital data representing the captured image or a digital file.

24. The non-transitory computer readable medium of claim 17, wherein the steps further comprise: sending a signal from the article sensor to the light source and the image capture device to respectively activate the light source and the image capture device.

25. The non-transitory computer-readable medium of claim 24, wherein the steps further comprise: turning off the light source and the image capture device after a predetermined time interval.

26. The non-transitory computer-readable medium of claim 17, wherein the steps further comprise:
sending a first signal from the article sensor to the processor indicating the presence of the returned article; and
sending a second signal from the processor to the light source and the image capture device to respectively activate the light source and the image capture device.

27. The non-transitory computer-readable medium of claim 26, wherein the steps further comprise: turning off the light source and the image capture device after a predetermined time interval.

28. The non-transitory computer-readable medium of claim 26, wherein the steps further comprise: turning off the light source and the image capture device after a predetermined number of images have been captured.

29. The non-transitory computer-readable medium of claim 26, wherein the steps further comprise: turning off the light source and the image capture device after authenticating the authentication code.

30. The non-transitory computer-readable medium of claim 17, wherein the authentication code is a data matrix.

31. The non-transitory computer readable medium of claim 17, wherein when the surface is illuminated, an article identifier disposed on the surface of the returned article is also visible through the layer, and the image captured by the image capture device further includes the article identifier.

32. The non-transitory computer readable medium of claim 31, wherein the steps further comprise:
identifying the article identifier from the image; and
updating an inventory database according to the article identifier.

33. The non-transitory computer readable medium of claim 31, wherein the article identifier is a serial number that identifies the returned article.

34. The non-transitory computer-readable medium of claim 31, wherein the authentication code and the article identifier are included in a data matrix.

35. The non-transitory computer-readable medium of claim 31, wherein the authentication code and the article identifier are printed in a carbon-containing ink that is visible in the predetermined range.
